(19) United States
(12) Patent Application Publication
(10) Pub. No.: US 2012/0052378 A1
(43) Pub. Date: Mar. 1, 2012

(54) COLLECTOR AND ELECTRODE FOR NONAQUEOUS SECONDARY BATTERY AND NONAQUEOUS SECONDARY BATTERY

(76) Inventors: Naoto Torata, Osaka (JP); Naoto Nishimura, Osaka (JP)

(21) Appl. No.: 13/215,554

(22) Filed: Aug. 23, 2011

(30) Foreign Application Priority Data
Aug. 25, 2010 (JP) 2010-188684

(51) Int. Cl. H01M 4/70; H01M 4/13

(52) U.S. Cl. 429/209; 429/234

(57) ABSTRACT

A collector for a nonaqueous secondary battery composing at least either one of a positive electrode and a negative electrode to be used for a nonaqueous secondary battery,

wherein the collector is constituted by a resin film and a conductive layer stacked on at least one of the surfaces thereof, and provided with a three-dimensional structural region having one or more concave portions and/or convex portions.

### CROSS-REFERENCE TO RELATED APPLICATION

This application is related to Japanese application No 2010-188684 filed on Aug. 25, 2010, whose priority is claimed under 35 USC §119, the disclosure of which is incorporated by reference in its entirety.

### BACKGROUND OF THE INVENTION

1. Field of the Invention

The present invention relates to a collector and an electrode for a nonaqueous secondary battery and a nonaqueous secondary battery using these. More specifically, the present invention relates to a collector for a nonaqueous secondary battery in which an active material layer formed thereon is effectively used, an electrode using such a collector and a nonaqueous secondary battery using such an electrode.

2. Description of the Related Art

A lithium ion secondary battery (hereinafter, referred to simply as “battery”), which is one type of nonaqueous secondary batteries in which a metal oxide is used as its positive electrode, an organic electrolytic solution is used as an electrolyte, a carbon material such as graphite is used as its negative electrode, and a porous separator is used between the positive electrode and the negative electrode, has been rapidly used widely since its first introduction as products in 1991 because of its high energy density, as batteries for portable apparatuses, such as cellular phones, whose miniaturized size and light weight have been developed progressively.

Moreover, a lithium ion secondary battery (large capacity battery) with an increased capacity so as to store generated electricity has also been examined. As the large capacity battery, an example in which the conventional battery is simply scaled up and produced has been reported.

Each of the positive electrode and the negative electrode is normally provided with an active material layer containing a positive electrode active material or a negative electrode active material (hereinafter, referred to simply as “active material”) formed on the collector. The collector is normally formed by using a metal foil.

In the lithium ion secondary battery, an organic electrolytic solution is used as the electrolyte. Therefore, it has been demanded that even under severe using conditions, no accident such as rupturing and igniting is caused. The metal foil has no such function for preventing these accidents. Therefore, WO 2009/131184 has proposed a system in which a film-state or fiber-state resin layer having conductive layers formed on the two surfaces thereof is used as a collector.

When an abnormal heat generation occurs in a battery having this collector, the resin layer is fused and disconnected so that the positive electrode and/or the negative electrode are damaged, thereby preventing a short-circuit between the electrodes. Consequently, the temperature rise in the inside of the battery is supposed to be suppressed.

The collector of WO 2009/131184 makes it possible to provide a battery with improved safety. In this case, the positive electrode or the negative electrode is obtained by forming an active material layer containing a positive electrode active material or a negative electrode active material on the collector, and it has been demanded that the positive electrode active material or the negative electrode active material in the active material layer is effectively used from the viewpoint of a charging/discharging reaction. In particular, in a large-capacity battery, a structure has been proposed in which by making the active material layer thicker, a sufficient capacity is ensured, and at a portion apart from the collector of the thick active material layer, the positive electrode active material or the negative electrode active material sometimes fails to devote to the charging/discharging reaction. In this case, the ratio of the actual capacity to the theoretical capacity becomes lower to sometimes cause a failure in obtaining a desired capacity.

### SUMMARY OF THE INVENTION

In accordance with the present invention, it provides a collector for a nonaqueous secondary battery composing at least either one of a positive electrode and a negative electrode to be used for a nonaqueous secondary battery, wherein the collector is constituted by a resin film and a conductive layer stacked on at least one of the surfaces thereof, and has a three-dimensional structural region having one or more concave portions and/or convex portions.

Also, in accordance with the present invention, it provides an electrode for a nonaqueous secondary battery which has the above-mentioned collector for a nonaqueous secondary battery and a positive electrode active material layer or a negative electrode active material layer formed on the three-dimensional structural region of the collector.

Moreover, in accordance with the present invention, it provides a nonaqueous secondary battery comprising a positive electrode, a negative electrode, a separator located between the positive electrode and the negative electrode, and an electrolyte, wherein at least either one of the positive electrode and the negative electrode is the above-mentioned electrode for a nonaqueous secondary battery.

These and other objects of the present application will become more readily apparent from the detailed description given hereinafter. However, it should be understood that the detailed description and specific examples, while indicating preferred embodiments of the invention, are given by way of illustration only, since various changes and modifications within the spirit and scope of the invention will become apparent to those skilled in the art from this detailed description.

### BRIEF DESCRIPTION OF THE DRAWINGS

FIGS. 1(a) and 1(b) include a plane view and a cross-sectional view that schematically show essential portions of a collector in accordance with Example 1.

FIGS. 2(a) and 2(b) include a plane view and a cross-sectional view that schematically show essential portions of a collector in accordance with Example 3.

### DETAILED DESCRIPTION OF THE PREFERRED EMBODIMENTS

(1) Collector for Nonaqueous Secondary Battery

A collector for a nonaqueous secondary battery (hereinafter, referred to simply as “collector”) of the present invention can be used as a collector for a positive electrode and a negative electrode. The collector of the present invention may be used for either one of a positive electrode and a negative electrode, or may be used for both of them. Moreover, as the nonaqueous secondary batter to which the collector of the present invention is applicable, for example, lithium ion secondary batteries and lithium metal secondary batteries are proposed. Among these, the lithium ion secondary battery in which the collector of the present invention can be used as both of the positive electrode and the negative electrode is preferably proposed.

The collector of the present invention is composed of a resin film and a conductive layer that is stacked on at least one of the surfaces thereof. The conductive layer may be stacked only on one surface of the resin film, or may be stacked on both of the surfaces thereof.

The thickness of the collector is preferably in a range of 0.01 to 0.1 mm. In the case when the thickness is thinner than 0.01 mm, it sometimes becomes difficult to maintain a three-dimensional structure or to sufficiently ensure a supporting property of an active material. In the case when the thickness is thicker than 0.1 mm, since the volume ratio of the collector that occupies the secondary battery becomes greater, it sometimes become difficult to make the battery capacity larger. More preferably, the thickness is in a range of 0.02 to 0.05 mm.

From the viewpoint of ensuring a sufficient collector characteristic, the sheet resistivity of the collector is preferably set to 0.1Ω/□ or less. The sheet resistivity is more preferably set to 0.05Ω/□ or less.

(a) Resin Layer

A material for the resin layer is not particularly limited as long as it allows a three-dimensional structural region to be for wed. From the viewpoint of safety of the battery, a resin material that is thermally deformed at the time of a temperature rise is preferably used. Examples of such a resin material include polyolefin resins, such as polyethylene (PE) and polypropylene (PP), and resin films, etc. made of polystyrene (PS) or the like, which have a thermal deformation temperature of 150° C. or less.

As the resin layer, a resin film that is manufactured by using any one of methods, such as a uniaxial stretching method, a biaxial stretching method, a non-stretching method and the like, may be used.

The thickness of the resin layer may be adjusted on demand so as to obtain a collector having the above-mentioned thickness. For example, the thickness is preferably made in a range of 0.01 to 0.1 mm. In the case when the thickness is thinner than 0.01 mm, it sometimes becomes difficult to maintain a three-dimensional structure or to sufficiently ensure a supporting property of an active material. In the case when the thickness is thicker than 0.1 mm, since the volume ratio of the collector that occupies the secondary battery becomes greater, it sometimes become difficult to make the battery capacity larger. The thickness is more preferably in a range of 0.015 to 0.05 mm.

(b) Conductive Layer

The conductive layer on the positive electrode side is preferably foamed by using aluminum, titanium or nickel, and the conductive layer on the negative electrode side is preferably formed by using copper or nickel.

The thickness of the conductive layer is not particularly limited, as long as sufficient conductivity is ensured, and it is normally in a range of 0.002 to 0.01 mm.

As the forming method of the conductive layer, a method such as vapor deposition, sputtering, electrolytic plating, electroless plating and a bonding method and a combined method of these may be used without being particularly limited. The conductive layer may be formed on the resin film prior to formation of a three-dimensional structural region, or may be formed on the resin film after the three-dimensional structural region has been formed thereon.

(c) Three-Dimensional Structural Region

The three-dimensional structural region is preferably made to occupy a half or more area of the resin film surface on the side where it is included. By allowing the region to occupy a half or more area thereof, an active material in an active material layer formed thereon can be used for a charging/discharging reaction with high efficiency. The upper limit of the rate at which the three-dimensional structural region occupies the surface of the resin film is the entire surface. In this case, however, since the collector has a structure in which a terminal used for taking electricity out is placed on either one of the end portions, a portion corresponding to the terminal portion is preferably formed into a flat portion with a range of 2 to 20 mm from the end portion. Therefore, from the viewpoints of efficiency in the charging/discharging reaction and the necessity of twilling the region for the formation of the terminal, the three-dimensional region preferably occupies the resin film surface in a range of 80 to 98%.

The three-dimensional region means a region in which one or more concave and/or convex portions are formed in the collector. In this case, the concave portions and convex portions mean states viewed from the conductive layer forming surface. Moreover, the collector may be provided with only the concave portions, or may be provided with only the convex portions, or may be provided with both of the concave portions and convex portions. In the case when both of them are placed thereon, the concave portions and convex portions may be alternately disposed, or a region having only the concave portions and a region having only the convex portions may be aligned side by side.

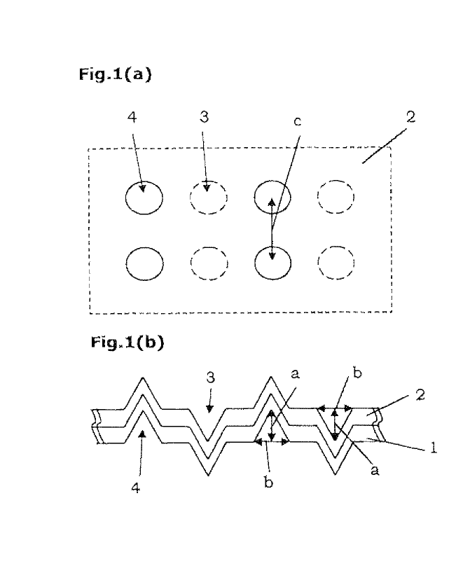

The concave portions and the convex portions may be disposed in such a manner as shown in the schematic plane view of essential portions of FIG. 1(a) and the schematic cross-sectional view of essential portions of FIG. 1(b).

The number of concave portions and convex portions in the three-dimensional structural region (in the case when both of the concave portions and convex portions are formed, the total number) is not particularly limited, as long as the effects of the present invention are not impaired. For example, it is made to be 0.1 piece/mm² or more per unit area. The upper limit of the number thereof corresponds to a number in which the concave portions and convex portions can be formed within the three-dimensional structural region, and for example, is 20 pieces/mm² or less. More preferably, it is set in a range of 0.5 to 10 pieces/mm².

The plane shape (the plane means a conductive-layer forming plane of the resin film) of the concave and convex portions is not particularly limited, as long as the effects of the present invention are not impaired. Examples thereof include: a round shape (see FIG. 1(a)), an elliptical shape, a triangular shape, a square shape, a pentagonal shape, a hexagonal shape, a polygonal shape of heptagonal or more, a star shape, an indefinite shape, etc. Among these, a round shape and a square shape are preferably used because of easiness in formation.

When the longest length of the uppermost length of the uppermost end of the concave portion and the longest length of the lowermost length of the lowermost end of the convex portion are too short, the effect for improving the conductivity becomes smaller, and when they are too long, it becomes difficult to uniformly form the active material layer. Therefore, those lengths are preferably in a range of 1 to 1000 μm, more preferably 5 to 500 μm. Here, for example, in the case of a round shape on the plane, the longest length corresponds to the diameter, and in the case of a square shape, it corresponds to the length of the diagonal line.

The cross-sectional shape of the concave portion and the convex portion is not particularly limited as long as it does not impair the effects of the present invention. For example, a triangular shape (see FIG. 1(b)), a square shape, a partially round shape, etc. are proposed. In the case when the concave portion and the convex portion have partially round shapes, by alternately arranging the concave portion and the convex portion with each other, a cross-sectional shape having a waveform may be prepared.

When the depth of the concave portion and the height of the convex portion are too short, the effect for improving the conductivity becomes smaller, and when they are too large, it becomes difficult to uniformly form the active material layer. Therefore, those lengths are preferably in a range of 50 to 1000 μm, more preferably 150 to 750 μm.

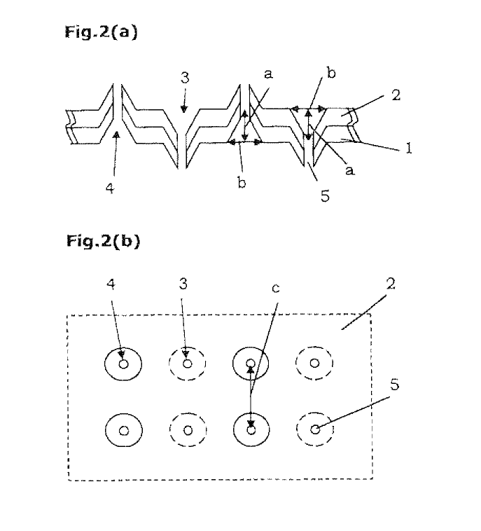

Moreover, the lowermost point of the concave portion and the apex of the convex portion may be provided with openings as shown in a plane view schematically showing essential portions of FIG. 2(a) and a cross-sectional view schematically showing essential portions of FIG. 2(b). By forming the openings, the flow of an electrolyte can be improved so that it is possible to provide a battery having a better charging/discharging efficiency. The plane shape of the openings is not particularly limited, and examples thereof include: a round shape, an elliptical shape, a triangular shape, a square shape, a pentagonal shape, a hexagonal shape, a polygonal shape of heptagonal or more, a star shape, an indefinite shape, etc. Among these, a round shape and a square shape are preferably used because of easiness in formation. When the largest length of the openings is too short, the effect for improving the flow of the electrolyte becomes smaller to sometimes cause a reduction in the strength of the collector. Therefore, the largest length is preferably in a range of 1 to 1000 μm, more preferably 5 to 300 μm. Additionally, in the case of a round shape on the plane, the longest length corresponds to the diameter, and in the case of a square shape, it corresponds to the length of the diagonal line.

Additionally, the openings may be formed on regions other than the positions shown in FIGS. 2(a) and 2(b), as long as they can improve the flow of the electrolyte.

In addition to those shown in FIGS. 1(a) to 2(b), the following specific examples of the three-dimensional structural region are proposed.

(d) Method for Forming Three-Dimensional Structural Region

The three-dimensional structural region can be formed by using, for example, a pressing method by the use of a male mold and a female mold, a punching machining method, a lath processing method, etc. Additionally, the formation of the three-dimensional structural region may be formed either before the formation of a conductive layer, or after the formation thereof.

(2) Electrode for Nonaqueous Secondary Battery

The electrode for a nonaqueous secondary battery (hereinafter, referred to simply as “electrode”) is provided with the above-mentioned collector and an active material layer formed on the three-dimensional structural region of the collector. In this case, the electrode means the positive electrode, the negative electrode or both of the positive electrode and the negative electrode. Moreover, in the case of a positive electrode, the active material layer forms a positive electrode active material layer. In the case of a negative electrode, the active material layer forms a negative electrode active material layer.

(a) Positive Electrode

(i) Positive electrode active material layer

As the positive electrode active material contained in the positive electrode active material layer, examples of the materials therefor include oxide containing lithium. Specific examples are: LiCoO₂, LiNiO₂, LiFeO₂, LiMnO₂, LiMn₂O₄, and materials in which one portion of transition metal of each of these oxides is substituted by another metal element (Co, Ni, Fe, Mn, Al, Mg, etc.), and oxides having an olivine structure represented by LiMPO₄ (M represents at least one or more kinds of elements selected from the group consisting of Co, Ni, Mn and Fe) and the like. Among these, positive electrode active materials using Mn and/or Fe are preferably used from the viewpoint of costs.

(ii) Other Additives

The positive electrode active material layer may contain a binder in addition to the positive electrode active material so as to be maintained as a layer.

Examples of the binder include: fluorine-based polymers, such as polyvinylidene fluoride (PVDF), polyvinylpyridine and polytetra fluoroethylene, polyolefin-based polymers, such as polyethylene and polypropylene, and styrene butadiene rubber, etc.

The positive electrode active material layer may contain other conductive material and thickener.

As the conductive material, those materials that are chemically stable are preferably used. Specific examples thereof include carbon-based materials, such as Carbon Black, Acetylene Black, Ketchen Black, graphite (natural graphite, artificial graphite), carbon fibers, and conductive metal oxides, etc.

As the thickener, examples thereof include polyethylene glycols, celluloses, polyacrylamides, poly N-vinyl amides, poly N-vinyl pyrrolidones, etc.

Although it is different depending on the kinds of the binder, the thickener and the conductive material to be mixed, the mixing ratio among the binder, the thickener and the conductive material is determined such that the binder is in a range of 1 to 50 parts by weight, the thickener is in a range of 0.1 to 20 parts by weight, and the conductive material is in a range of 0.1 to 50 parts by weight, based upon 100 parts by weight of the positive electrode active material. When the binder is about 1 part by weight or less, the binding capability sometimes tends to become insufficient; in contrast, when it is about 50 parts by weight or more, the mass of the active material contained in the positive electrode is reduced, with the result that the resistivity, or the polarization or the like of the positive electrode becomes greater to sometimes cause the discharging capacity to become smaller. Moreover, when the thickener is about 0.1 part by weight or less, the thickening capability sometimes tends to become insufficient; in contrast, when the thickener is greater than about 20 parts by weight, the mass of the active material contained in the positive electrode is reduced, with the result that the resistivity, or the polarization or the like of the positive electrode becomes greater to sometimes cause the discharging capacity to become smaller. Furthermore, in the case when the conductive material is about 0.1 part by weight or less, the resistivity, or the polarization or the like of the electrode becomes greater to sometimes cause the discharging capacity to become smaller, while in the case when it is about 50 parts by weight or more, since the mass of the active material contained in the electrode is reduced, the discharging capacity as the positive electrode sometimes becomes smaller.

(b) Negative Electrode

(i) Negative Electrode Active Material Layer

As the negative electrode active material contained in the negative electrode active material layer, examples of the materials therefor include natural graphite, particle-state (such as scale-shaped, lump-shaped, fiber-shaped, whisker-shaped, spherical, pulverized, or the like) artificial graphites, or highly crystalline graphites typically represented by graphite products, such as meso-carbon microbeads, meso-phase pitch powder, or isotropic pitch powder, and carbon materials that are hardly graphitized, such as sintered resin carbon. Each of these negative electrode active materials may be made from one kind, or may be formed as a mixture of two or more kinds of these. Moreover, an alloy-based material having a great capacity, such as a tin oxide and a silicon-based negative electrode active material, may also be used.

(ii) Other Additives

The negative electrode active material layer may contain other additives, such as a binder, a conductive material and a thickener, in the same manner as in the positive electrode active material layer. As the other additives, any of the materials described in the column of the positive electrode active material layer may be used.

(c) Forming Method

The active material layer may be formed, for example, by using a conventionally known method, such as a method in which a paste containing an active material and other desired additives is applied onto the three-dimensional structural region of a collector, and the resulting coated film is dried. Moreover, by repeating the coating process and the drying process, a thick positive electrode active material layer may be formed. Furthermore, after the drying process, the layer may be subjected to a pressing process so as to improve the processability of the electrode of the electrode layer.

The active material layer may cover the entire surface of the collector, or may cover a collector region except for portions used for forming terminals. The active material layer may be formed on each of the two surfaces of the collector. Moreover, two sheets of collectors, each having an active material layer formed on one of the surfaces, are prepared, and the other surfaces without the active material layer formed thereon of the two sheets of the collectors may be bonded to each other so that an electrode may be prepared, with active material layers being formed on its two surfaces.

In the present invention, since the collector is provided with concave portions and/or convex portions, it is possible to reduce the active material that does not devote to a charging/discharging reaction in comparison with a flat collector, even if a thick active material layer is formed. For example, an active material layer having a thick film, with the largest thickness in a range of 0.3 to 1.5 times the depth or height of the concave portion or the convex portion, may be used. In the case when only the convex portions are placed, the largest thickness corresponds to a length from the lowest portion of the convex portion to the top surface of the active material layer, and in the case when only the concave portions, or both of the concave portions and the convex portions are placed, the largest thickness corresponds to a length from the lowermost portion of the concave portion to the top surface of the active material layer.

Moreover, the positive electrode active material layer or the negative electrode active material layer may contain a positive electrode active material or a negative electrode active material from 100 to 1000 g/m² by weight per area of the positive electrode or the negative electrode, more preferably, a positive electrode active material or a negative electrode active material from 100 to 600 g/m².

(3) Nonaqueous Secondary Battery

The nonaqueous secondary battery includes a positive electrode, a negative electrode, a separator positioned between the positive electrode and the negative electrode, and an electrolyte.

(a) Electrode

At least one of the positive electrode and the negative electrode is the above-mentioned electrode for the nonaqueous secondary battery.

Both of the positive electrode and the negative electrode may be the above-mentioned electrodes for the nonaqueous secondary battery, or either one of them may be the above-mentioned electrode for the nonaqueous secondary battery.

As the electrode other than the above-mentioned electrode for the nonaqueous secondary battery, a conventionally known electrode, composed of a flat collector (metal foil, a laminated member of a conductive layer and a resin film, etc.) and an active material layer formed thereon, is proposed.

(b) Separator

The material for the separator may be selected on demand from materials, such as non-woven, woven or fine porous films of electrically insulating synthetic resin fibers, glass fibers, natural fibers. Among these, non-woven fabrics and fine porous films of polyethylene, polypropylene, polyester, aramid-based resins, cellulose-based resins, etc., are preferably used from the viewpoint of stability of quality, or the like. Some of these non-woven fabrics of synthetic resins and fine porous films have an additional function in that in the case of an abnormal heat generation of the battery, the separator is melted by heat so as to cut off the connection between the positive and negative electrodes, so that these are preferably used also from the viewpoint of safety.

Although not particularly limited, the thickness of the separator is desirably determined to such a thickness as to hold an electrolyte having a required amount, and prevent short-circuit between the positive electrode and the negative electrode. For example, it is set in a range of about 10 to 1000 μm, more preferably about 20 to 50 μm. A material for forming the separator is preferably provided with an air permeable degree of 1 to 500 seconds/cm³; thus, it is possible to ensure strength that sufficiently prevents an inner short-circuit of the battery, while maintaining a low resistivity inside the battery.

The shape and size of the separator are not particularly limited, and for example, various shapes, such as a rectangular shape like a square and a rectangle, a polygonal shape, a round shape, etc., may be used. Moreover, in the case when both of the positive electrode and the negative electrode are stacked, the separator is preferably designed to be larger than the positive electrode, and in particular, preferably has a symmetric shape that is slightly larger than the positive electrode and also slightly smaller than the negative electrode.

(c) Electrolyte

As the electrolyte, in general, an electrolytic solution containing an organic solvent and an electrolyte salt is used.

As the organic solvent, examples thereof include: cyclic carbonates, such as propylene carbonate (PC), ethylene carbonate (EC) and butylene carbonate; chain carbonates, such as dimethyl carbonate (DMC), diethyl carbonate, ethylmethyl carbonate and dipropyl carbonate; lactones, such as γ-butyrolactone, γ-valerolactone, etc.; furans, such as tetrahydrofuran, 2-methyltetrahydrofuran, etc.; ethers, such as diethylether, 1,2-dimethylethane, 1,2-diethoxyethane, ethoxymethoxyethane, dioxane, etc.; dimethylsolfoxide, sulfolane, methylsulfolane, acetonitrile, methylformate, methyl acetate, etc. Two Or more kinds of these organic solvents may be mixed with one another.

Examples of the electrolytic salt include: lithium salts, such as lithium borofluoride (LiBF₄), lithium phosphofluoride (LiPF₆), lithium trifluoromethane sulfonate (LiCF₃SO₃), lithium trifluoroacetate (LiCF₃COO), lithium trifluoromethane sulfonic acid imide (LiN (CF₃SO₂)₂), etc. Two or more kinds of these electrolytic salts may be mixed with one another.

Moreover, a gel electrolyte in which the electrolytic solution is held in a polymer matrix, or an electrolyte made from an ionic solution may be used.

(d) Others

The battery may be held in an external can or a bag made of a resin film.

As the external can, a metal can, that is, a material made of iron onto which nickel plating is applied, is preferably used. This material makes it possible to maintain sufficient strength as an external can at low costs. Cans made of other materials, for example, stainless steel, aluminum, etc. may also be used. Moreover, the shape of the external can may be prepared as any one of a thin flat-tube type, a cylindrical type, a rectangular-tube type, etc.; however, in the case of a large-size lithium secondary battery, the flat-tube type or the rectangular-tube type is preferably used, because this battery is often used as a part of combined batteries.

### EXAMPLES

The following description will discuss the present invention in detail by reference to examples; however, the present invention is not intended to be limited by these.

### Example 1

By using 100 parts by weight of LiMn₂O₄ as a positive electrode active material, 10 parts by weight of a conductive material (Denka Black made by Denki Kagaku Kogyo K.K.), 10 parts by weight of PVDF (KF polymer (registered trademark) made by Kureha Corp.) as a binder, and N-methyl-2-pyrrolidone (hereinafter, referred to as “NMP”) as a solvent, a paste for use in forming a positive electrode active material layer was prepared.

In example 1, as shown in a schematic plane view showing essential portions of FIG. 1(a) and a schematic cross-sectional view showing essential portions of FIG. 1(b), a laminated film made of a stacked member of an aluminum foil having a thickness of 6.5 μm and a polyolefin-based resin layer having a thickness of 20 μm was processed into a three-dimensional shape (plane shape, rectangular: length 250 mm, width 150 mm), and used as a positive electrode collector. The outline of a three-dimensional structural region will be explained below:

Total number of concave portions and convex portions: 75000 pcs (2 pcs/mm²: pcs per unit area)

Plane shape of concave portions and convex portions: circle

Cross-sectional shape of concave portions and convex portions: triangular shape

Depth of concave portions and height of convex portions: 200 μm

Diameter of uppermost top end of concave portions and lowermost end of convex portions: 100 μm

On the plane view, ranges, each having a width of 5 mm, from the two ends are plane surfaces without any of concave portions and convex portions.

In FIGS. 1(a) and 1(b), reference numeral 1 represents a resin film, 2 represents a conductive layer, 3 represents a concave portion, 4 represents a convex portion, a represents a depth of the concave portion and a height of the convex portion, b represents each of diameters of the uppermost top end of the concave portion and the lowermost end of the convex portion, and c represents a distance between the lowermost point of the concave portion and the apex of the convex portion that are located closest to each other on the plane view.

The above-mentioned paste was applied to the two surfaces of the positive electrode collector, and after having been sufficiently dried, this was subjected to a pressing process so that a positive electrode having positive electrode active material layers (largest thickness=230 μm) on the two surfaces thereof was obtained (size of positive electrode coated portion: width 200 mm×length 150 mm).

Next, by using 100 parts by weight of natural graphite (average particle size: 15 μm, d002=0.3357 nm, BET specific surface area 3 m²/g made in China) as a negative electrode active material, 12 parts by weight of the aforementioned PVDF as a binder, and the NMP as a solvent, a paste for use in forming a negative electrode was prepared. This paste was applied to two surfaces of a copper foil as negative electrode collectors, and after having been sufficiently dried, this was subjected to a pressing process so that a negative electrode provided with negative electrode active material layers was obtained (size of negative electrode coated portion: width 205 mm×length 158 mm).

A nonwoven fabric of an aramid-based resin having a width of 205 mm, a length of 158 mm and a thickness of 36 μm (made by Japan Vilene Co., Ltd., rate of thermal shrinkage at 200° C.:1.0% or less, hereinafter, referred to as “aramid-based resin layer) was used as a separator, and a battery element was obtained by stacking separators, positive electrodes and negative electrodes in the following order: that is, negative electrode/separator/positive electrode/separator/negative electrode/separator/positive electrode/separator/negative electrode/separator/positive electrode/separator/negative electrode/separator/positive electrode/separator/negative electrode/separator/positive electrode/separator/negative electrode/separator/positive electrode/separator/negative electrode/separator/positive electrode/separator/negative electrode/separator/positive electrode/separator/negative electrode/separator/positive electrode/separator/negative electrode. Moreover, tabs are welded to the respective positive and negative electrodes. The resulting battery element was inserted into a can.

Additionally, the rate of thermal shrinkage was measured in the following manner. First, two points are attached onto a resin film, with a gap of 50 mm or more being placed therebetween, and the distance between the two points was measured by using calipers. Then, after carrying out a heating process at 200° C. thereon for 15 minutes, the same point-to-point distance was again measured so that based upon the measured values before and after the heating process, the rate of thermal shrinkage was found. Based upon this method, in each of the longitudinal direction and lateral direction of the resin film, three or more point-to-point distances were measured respectively so that the average value of the rates of thermal shrinkage calculated from the results of the measurements was adopted as the final rate of thermal shrinkage of the resin film. In this case, in each of the longitudinal direction and the lateral direction of the resin film, at least two points within 10% from the end portion of the resin film and one point before and after 50% from the end portion of the resin film were selected as measuring points of the point-to-point distance. A greater value in either of the longitudinal and lateral directions was defined as the rate of thermal shrinkage.

As the electrolytic solution, a solution, obtained by dissolving 1M of LiPF₆ in a solvent in which ethylene carbonate (EC) and dimethyl carbonate (DMC) were mixed so as to be 1:1 in volume ratio, was used. This electrolytic solution was poured into the can, and held under a reduced pressure. Next, after having been returned to the atmospheric pressure, the outer circumference of a lid was sealed so that a battery was manufactured.

### Example 2

The same processes as those of example 1 were carried out except that a laminated film composed of an aluminum foil of 6.5 μm/a polyolefin-based resin layer of 20 μm/and an aluminum foil of 6.5 μm was processed into a three-dimensional shape, and used as a positive electrode collector.

### Example 3

The same processes as those of example 1 were carried out except that a laminated film composed of an aluminum foil of 6.5 μm/a polyolefin-based resin layer of 20 μm/and an aluminum foil of 6.5 μm was processed into a three-dimensional shape so as to have openings at the lowermost point of a concave portion as well as at the apex of a convex portion, and used as a positive electrode collector. In this case, the plane shape of each opening had a round shape, with the diameter of the opening being 200 μm. FIG. 2(a) is a schematic plane view showing an essential portion of the positive electrode collector, and FIG. 2(b) is a schematic cross-sectional view showing an essential portion of FIG. 2(a). In FIGS. 2(a) and 2(b), reference numeral 5 represents an opening, and d represents the diameter of the opening while the others are the same as those shown in FIGS. 1(a) and 1(b).

### Comparative Example 1

The same processes as those of example 1 were carried out except that an aluminum foil having a thickness of 20 μm was used as the positive electrode collector.

Batteries of examples 1 to 3 and comparative example 1 were subjected to the following charging/discharging tests and nail-penetration tests, and evaluated.

(Charging/Discharging Test)

### Test Conditions

Charging: Charged with constant-current and constant-voltage of charging current 0.2 C and end voltage 4.2 V for 20 hours, or charging current of 10 mA cutoff.

Discharging: Constant-current discharged with discharging current of 0.2 C, 0.5 C and 1 C, with end voltage 3.0 V cutoff.

Charging/discharging tests were carried out under the above-mentioned conditions. Based upon the time required for discharging to 3.0 V, discharge capacities at the time of a discharging current 1.0 C and at the time of a discharging current 0.1 C were calculated. In Table 1, a ratio between the discharge capacity at the time of 1.0 C and the discharge capacity at the time of 0.1 C is shown.

(Conditions of Nail-Penetration Test)

After having been subjected to the charging/discharging tests, each of the batteries was subjected to a nail-penetration test by the use of a nail of 2.5 mmφ with its fully-charged state, and the behaviors and surface temperature of the battery were observed.

Table 1 shows the results of the charging/discharging tests and the nail-penetration test.

TABLE 1

| | | Results of nail-penetration test | |
|---|---|---|---|
| | Capacity ratio | | Highest surface |
| | 1.0 C/0.1 C | Behaviors | temperature |
| Example 1 | 0.87 | No changes | 58° C. |
| Example 2 | 0.86 | No changes | 62° C. |
| Example 3 | 0.91 | No changes | 65° C. |
| Comparative | 0.93 | Immediately after having | Unmeasurable |
| Example 1 | | been nail-pierced, the | |
| | | cell was swelled and | |
| | | ruptured to be ignited. | |

Table 1 makes it possible to confirm that batteries of examples 1 to 3, which use a positive electrode collector having a three-dimensional structure processed by using a resin film having a conductive layer on at least one of the surfaces thereof, have battery characteristics equivalent to those of the battery of comparative example 1 in the charging/discharging tests, and are proved by the nail-penetration test to be capable of suppressing the rising speed and the highest arrival temperature of the highest surface temperature, and consequently to be confirmed as batteries with high safety.

### Single Electrode Test Evaluation

### Examples a to c and Comparative Examples a to c

By using 100 parts by weight of LiFePO₄ as a positive electrode active material, 10 parts by weight of a conductive material (Denka Black made by Denki Kagaku Kogyo K.K.), 10 parts by weight of PVDF (KF polymer (registered trademark) made by Kureha Corp.) as a binder, and N-methyl-2-pyrrolidone (hereinafter, referred to as “NMP”) as a solvent, a paste for use in forming a positive electrode active material layer was prepared.

The same processes as those of example 1 were carried out except that the weight of the active material per area was changed as shown in Table 2 so that positive electrodes of examples a to c were produced, and the same processes as those of comparative example 1 were carried out so that positive electrodes of comparative examples a to c were produced.

The electrodes of examples a to c and comparative examples a to c were evaluated by the following charging/discharging tests.

(Charging/Discharging Test)

### Test Conditions

Charging: Charged with constant-current and constant-voltage of charging current 0.2 C and end voltage 3.8 V for 20 hours, or charging current of 10 mA cutoff.

Discharging: Constant-current discharged with discharging current of 0.2 C, 0.5 C and 1 C, with end voltage 2.0 V cutoff.

Charging/discharging tests were carried out under the above-mentioned conditions. Based upon the time required for discharging to 2.0 V, discharge capacities at the time of a discharging current 1.0 C and at the time of a discharging current 0.2 C were calculated, and shown in Table 2.

TABLE 2

| | Weight of active | 0.2 C Capacity | 1.0 C Capacity/ |
|---|---|---|---|
| | material per area (g/m²) | (mAh/g) | 0.2 C Capacity |
| Example a | 175 | 148.3 | 91.8% |
| Example b | 315 | 142.5 | 88.0% |
| Example c | 415 | 136 | 86.0% |
| Comparative | 158 | 151.2 | 91.0% |
| Example a | | | |
| Comparative | 293 | 138.2 | 78.0% |
| Example b | | | |
| Comparative | 370 | 0 | — |
| Example c | | | |

From comparisons between example a and comparative example a, between example b and comparative example b, as well as between example c and comparative example c, it is confirmed that the rate (1.0 C capacity/0.2 C capacity) of capacities is greater in the three-dimensional collector of examples than that of the collector of comparative examples having a flat collector. Moreover, from comparisons between example c and comparative example c, it is confirmed that even in the case of a large weight per area the capacity to be used for the charging/discharging reaction can be increased.

In accordance with the collector for a nonaqueous secondary battery of the present invention, in comparison with a flat collector, even an active material located at a portion apart from the collector in the active material layer formed thereon can be used efficiently for a charging/discharging reaction. For this reason, since the theoretical capacity and the actual capacity can be made closer to each other, it is possible to provide a collector and an electrode for a nonaqueous secondary battery that provide a greater amount to be practically used than that of the prior art, in the case when the same amount of the active material is used. Moreover, in the case of the same amount of the active material, it is possible to provide a nonaqueous secondary battery having a greater amount of capacity to be practically used in comparison with the prior art.

Since a resin film is used in the collector, even upon occurrence of a short circuit between the positive electrode and the negative electrode due to a foreign matter, the resin film is fused and separated due to heat generated in the short circuit so that the resistivity in the vicinity of the short circuit can be increased. As a result, since the short circuit between the positive electrode and the negative electrode can be interrupted, it is possible to improve the safety of the battery.

Moreover, in the case when the three-dimensional structural region is provided with one or more openings, it is possible to provide a collector that can effectively utilize an active material for a charging/discharging reaction, and also to improve the flow of an electrolytic solution.

Furthermore, in the case when the three-dimensional structural region has an opening having a maximum diameter in a range of 1 to 1000 μm, it is possible to provide a collector that can effectively utilize an active material for a charging/discharging reaction, and also to improve the flow of an electrolytic solution.

In the case when the three-dimensional structural region occupies a half or more portion of the surface of the resin film on a side to which the structural region belongs, it is possible to provide a collector that can effectively utilize an active material for a charging/discharging reaction.

Moreover, in the case when the collector for a nonaqueous secondary battery has a flat portion having a width in a range of 2 to 20 mm from the end on at least one portion on its peripheral area, it is possible to provide a collector that can effectively utilize an active material for a charging/discharging reaction, and easily form a terminal.

Furthermore, in the case when the concave portion or the convex portion has a depth or a height in a range of 150 to 750 μm, it is possible to provide a collector that can effectively utilize an active material for a charging/discharging reaction.

In the case when the positive electrode active material layer or the negative electrode active material layer contains a positive electrode active material or a negative electrode active material in weight in a range of 100 to 1000 g/m² per area of the positive electrode or the negative electrode, it is possible to provide an electrode that can effectively utilize an active material for a charging/discharging reaction irrespective of a thick film or a thin film.

What is claimed is:

1. A collector for a nonaqueous secondary battery composing at least either one of a positive electrode and a negative electrode to be used for a nonaqueous secondary battery,
wherein the collector is constituted by a resin film and a conductive layer stacked on at least one of the surfaces thereof, and provided with a three-dimensional structural region having one or more concave portions and/or convex portions.

2. The collector for a nonaqueous secondary battery according to claim 1, wherein the three-dimensional structural region has at least one or more openings.

3. The collector for a nonaqueous secondary battery according to claim 1, wherein the three-dimensional structural region has an opening with a maximum diameter in a range of 1 to 1000 μm.

4. The collector for a nonaqueous secondary battery according to claim 1, wherein the three-dimensional structural region occupies a half or more portion of the surface of the resin film on a side to which the structural region belongs.

5. The collector for a nonaqueous secondary battery according to claim 1, the collector comprises: a flat portion having a width in a range of 2 to 20 mm from the end thereof on at least one portion on the periphery thereof.

6. The collector for a nonaqueous secondary battery according to claim 1, wherein the concave portion or the convex portion has a depth or a height in a range of 150 to 750 μm.

7. The collector for a nonaqueous secondary battery according to claim 1, wherein the number of the concave portion or the convex portion is in a range of 0.1 to 20 piece/mm².

8. The collector for a nonaqueous secondary battery according to claim 1, wherein the plane shape of the concave portion or the convex portion is a round shape or a square shape.

9. The collector for a nonaqueous secondary battery according to claim 1, wherein three-dimensional structural region has one or more concave portion and one or more convex portion, the cross-sectional shape of the concave portion and the convex portion is a triangular shape, and the plane shape of the concave portion and the convex portion is a round shape.

10. An electrode for a nonaqueous secondary battery comprising:
a collector for a nonaqueous secondary battery disclosed of claim 1; and
a positive electrode active material layer or a negative electrode active material layer formed on the three-dimensional structural region of the collector.

11. The electrode for a nonaqueous secondary battery according to claim 10, wherein the positive electrode active material layer or the negative electrode active material layer contains a positive electrode active material or a negative electrode active material having a weight per area of the positive electrode or the negative electrode in a range of 100 to 1000 g/m².

12. A nonaqueous secondary battery comprising:
a positive electrode; a negative electrode; a separator located between the positive electrode and the negative electrode; and an electrolyte,
wherein at least either one of the positive electrode and the negative electrode is the electrode for a nonaqueous secondary battery of claim 11.
